(19) United States
(12) Patent Application Publication
(10) Pub. No.: US 2003/0215352 A1
(43) Pub. Date: Nov. 20, 2003

(54) Method of controlling microbial contamination

(75) Inventors: Anthony E. Winston, (US); Benny Sin Hoi Yam, Holmdel, NJ (US); Melvin H. Czechowski, Doylestown, PA (US); Richard Daniel Miller, Union Beach, NJ (US)

Correspondence Address: Irving M. Fishman, Esq., Church & Dwight Co., Inc., 469 North Harrison Street, Princeton, NJ, 08543, US

(73) Assignee: Church & Dwight Co., Inc.

(21) Appl. No.: 10/147,253

(22) Filed: May 16, 2002

(51) Int. Cl. A01N 1/00

(52) U.S. Cl. 422/1; 422/2; 422/40

(57) ABSTRACT

A method of controlling microbial contamination and cross-contamination is disclosed using an (alkali metal or ammonium) (bicarbonate or carbonate) salt contained within a product having an absorbent material with or without a moisture impermeable backing. Where there is no backing, the salt may be impregnated within the absorbent material or may be layered between two plies of absorbent materials.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

The invention relates to alkali metal and ammonium bicarbonate and carbonate-containing products and to absorbent materials having alkali metal and ammonium bicarbonates and carbonates contained within such products. The invention also relates to microbial growth hindrance or reduction. Most specifically, the invention relates to the prevention or reduction of cross-contamination of microbes from one source to another. The invention further relates to an absorbent, layered sheet having alkali metal and ammonium bicarbonates and carbonates contained within and/or between the layers.

### BACKGROUND OF THE INVENTION

Liners for refrigerators have been known for some time. Such liners have been known for use with sodium bicarbonate as well. U.S. Pat. No.5,046,604 (incorporated herein by reference), for example, discloses an odor-absorbing multi-layered sheet having an odor-absorbing material contained between the sheets. The sheet is said to absorb odors and can be used as a shelf liner in the refrigerator, or in a cabinet or in a drawer, or other household containers. This patent indicates that other odor absorbing powders may be used in place of sodium bicarbonate to achieve the odor reduction. WO 01/89411 (incorporated herein by reference), published Nov. 29, 2001, is also directed to an “Absorbent Structure for Neutralizing Odour and Absorbing Liquid”. The structure set forth there is discussed in the context of controlling odors and absorbing liquids which might be found in the same places that the offensive odors are located. Other odor absorbing systems utilizing materials such as activated carbon, zeolites, or silica, etc. are mentioned in U.S. Pat. No. 5,782,409; and U.S. Pat. No. 5,611,486, each incorporated herein by reference. PCT/US99/26969 discloses the use of absorbent materials inside sealed impervious containers.

U.S. Pat. No. 3,946,118 provides a means of keeping fruit and vegetables fresh by using calcium peroxide. The inventors suggest that the calcium peroxide destroys ethylene gas which promotes early ripening. It is further suggested that the calcium peroxide degrades to calcium oxide, which then combines with the carbon dioxide emitted by the produce. Since carbon dioxide adversely affects the freshness of fruits and vegetables, the lower carbon dioxide level promotes the freshness of the fruits and vegetables. The patent states that the carbon dioxide levels should be kept below 1% and the oxygen levels below 10% to keep fruit fresh.

Zeolite containing products have been promoted for helping to maintain the freshness of fruits and vegetables by lowering the moisture levels within refrigeration units so that the refrigerator temperature is lowered. Lower refrigerator temperature is presumed to lower bacterial growth and thereby maintain the freshness of the produce.

Permanganate salts are known to scavenge ethylene gas. One product (Ripefully Yours) utilizes potassium permanganate as an ethylene scavenger in combination with a bulk container of sodium bicarbonate along with zeolite. The product is labeled as “Baking Soda with Ethylene Eliminator” and states that the baking soda will eliminate odors while the ethylene eliminator will reduce ethylene and retard spoilage.

Sodium bicarbonate has been well known to be a deodorizer and has been used for decades in refrigerators as powders in open boxes or as powder in boxes having one or more gas permeable openings therein. As discussed in U.S. Pat. No. 5,046,604 and WO01/89411, liners having sodium bicarbonate therein have been proposed for shelf liners in refrigerators. However, such liners have not to date been advocated to extend the shelf life of the fruits and vegetables with which they are in contact or to limit bacterial or other microbial growth.

Sodium bicarbonate enclosed within a top sheet and a water-impermeable layer is also known in the form of “puppy training pads”. These pads are used to absorb liquid waste and deodorize the liquid waste. The sodium bicarbonate may or may not contain further fragrant material to help cover the offensive odor of dried urine.

Sodium bicarbonate is also used in the context of agrochemicals as a herbicide and fungicide, but these applications do not involve absorbent materials.

All of the foregoing references are incorporated herein by reference in their entirety.

### OBJECTS OF THE INVENTION

It is therefore an object of the invention to provide an absorbent sheet having microbial contamination reducing properties.

It is another object of the invention to provide an absorbent sheet product that can reduce cross contamination.

It is yet another object of the invention to provide an anti-bacterial contamination or cross-contamination inhibiting sheet which when used as a refrigerator bin liner results in extended shelf life or fruits and vegetables stored thereon.

Yet further objects of the invention will be appreciated by those of ordinary skill in the art.

### BRIEF SUMMARY OF THE INVENTION

Surprisingly, these and other objects of the invention are achieved by an absorbent sheet having an alkali metal or ammonium bicarbonate and/or carbonate impregnated therein or contained between absorbent sheets or contained between an absorbent sheet and a moisture impermeable backing layer which result in an actual reduction in bacterial count when the sheet is contaminated with bacteria to a greater extent than would be achieved if the sheet did not contain the bicarbonate and/or carbonate salt.

### BRIEF DESCRIPTION OF THE SEVERAL VIEWS OF THE DRAWING

Not Applicable

### DETAILED DESCRIPTION OF THE INVENTION

In general, the invention is an absorbent product having at least one absorbent layer and at least one salt selected from those having an alkali metal or ammonium cation and either bicarbonate or carbonate as the anion. Preferably, the salt is an alkali metal or ammonium bicarbonate. Also preferably the salt is an alkali metal bicarbonate or carbonate, more preferably the alkali metal is sodium or potassium, and still more preferably the alkali metal is sodium. The most preferred salt is sodium bicarbonate. For convenience, the remainder of the detailed description will merely refer to “salt” which will be deemed to include all of the foregoing alkali metal and ammonium bicarbonate and carbonate salts, unless the specifically stated otherwise.

As stated, the invention requires at least one absorbent layer and at least one of the foregoing salts. In those embodiments where a single layer is employed, that layer preferably has the salt impregnated, coated, or absorbed onto or into the single layer; however, it is within the scope of the invention to have an absorbent layer where the salt is simply layered beneath or on top of the single layer by the consumer of the sheet. In such a context, the product is essentially a “kit” for assembling the invention, with instructions to the consumer for proper assembly in one or more conditions of use. Notwithstanding the above, the provision of an absorbent layer and separate salt for assembly by the consumer is substantially less desirable than the other embodiments which have the salt impregnated in, layered on, absorbed on or in, or otherwise fixed to the absorbent layer or the further embodiments which place the salt between an absorbent layer and another layer of any kind.

Virtually any amount of the salt may be used in association with an absorbent layer to achieve some level of benefit according to the invention. Nonetheless, the salt should preferably be used in an amount which is at least about 0.1% by weight relative to the weight of the entire absorbent product of the invention, preferably at least 0.2%, more preferably at least 0.5%, still more preferably 1.0%, yet more preferably at least 2%. In another embodiment of the invention, these percentages may be used based on the weight of the entire absorbent product except for any impermeable backing layer which may contained in the product. While there is no limit on having a maximum amount of the salt present, generally, amounts in excess of about 12% by weight relative to the weight of the entire absorbent product layer does not provide any additional benefit. Therefore, suitable amounts of salt for use in the invention are typically up to about 12%, up to about 10%, up to about 8%, up to about 6%, up to about 4%, up to about 2%, all relative to the weight of the entire absorbent product of the invention. In another embodiment of the invention, these percentages are calculated based on the weight of entire absorbent product of the invention except for any moisture impermeable backing layer that may be thereon. The preferred basis for all of the above percentage limits is however based on the entire weight of the absorbent product of the invention.

Where a single absorbent layer is used with no other layers and the salt is applied by the consumer, it can be spread, preferably somewhat uniformly, either below or above the absorbent layer, however, the salt should be either directly on or directly below the absorbent layer that is exposed to environment.

In more preferred embodiments, the product is prepared for sale with the salt already associated in one fashion or another (as will be explained in further detail below) with the absorbent layer. In one variant, the absorbent layer has the salt absorbed, impregnated therein, or coated thereon. Generally one can achieve this by preparing a solution of the salt and spraying the solution onto the absorbent layer and allowing the solvent to evaporate. Depending on whether the solvent used is absorbed into the absorbent layer or not, the result will either be that the salt is adsorbed into the absorbent layer or coated thereon. An alternative is to immerse the absorbent sheet into the salt solution and then allow it to dry. Another alternative is to sprinkle a suitable amount of the salt onto an absorbent or other layer and wet it with a spray of water or volatile solvent to tack the particles to the surface. Where the sheet to which the particles are applied is absorbent, the sheet can be used alone or in combination with other layers as described herein. However, if the sheet to which the salt particles have been applied is not absorbent, then such a sheet is used in conjunction with an absorbent sheet cover layer (as described further herein). A still further alternative is to add the salt to the absorbent sheet during the manufacturing process. For example in making a paper absorbent sheet, adding the appropriate amount of salt to the general mix of paper mulch used in the making of the paper so that as the paper web forms, the salt is embedded within the paper web. If the salt desired is a bicarbonate salt, the drying is preferably conducted in a carbon dioxide atmosphere of 5-100% carbon dioxide depending on the drying temperature and desired bicarbonate:carbonate ratio. Higher carbon dioxide levels are needed for maintaining a given ratio when drying at higher temperatures.

Such absorbent layers as outlined above may be used alone or backed with a moisture impermeable layer, or encased between a moisture impermeable backing below and a second salt-free absorbent layer as a top coating so that the salt containing absorbent layer is sandwiched between the backing and covering. Alternatively, the absorbent layers containing the salt may be sandwiched between the non-absorbent layers, one or both of which are moisture permeable.

Preferably, the bicarbonate is applied to the absorbent layer uniformly and in a fashion that the particles remain trapped in place. However, the particles can be applied loosely and outer layers can be utilized to hold the salt in place.

In a preferred embodiment, the invention has a moisture impermeable backing and a non-absorbent, but moisture permeable layer covering, and the salt is contained therebetween. The salt can be in powder form, or absorbed, coated, or otherwise impregnated into or on a carrier layer, which carrier layer, if present, is preferably absorbent as well. Preferably, the moisture permeable layer has pores small enough to prevent stray salt particles from powdering out of the carrier layer. Also, preferably, where loose powdered salt is utilized with a backing and top covering layer, the outer layers are quilted as quilting helps to insure that the salt, remains fairly well distributed across the sheet from manufacture through use by the consumer, but quilting is not a necessity.

Materials for the absorbent layer are any moisture absorbent materials, and these may be used for both the layer that contains the salt as well as the top covering sheet, although it is preferable to have different materials for each of these layers, with the top layer being permeable, but non-absorbent. Particularly suitable materials for the absorbent layer include (but are not limited to): paper, wood pulp, wood fiber, cotton, linen, papyrus, plant fiber, wool, camel hair, silk, nylon, cellulose, fiber-glass, polyester, polyamide, polyacrylic, triacetate, polypropylene, polypropylene/pulp blends, natural and synthetic fabric, and mixtures thereof. Spunbond polypropylene is preferred for the covering layer. Especially preferred is Spunbond polypropylene having a weight of about 1.3 oz/square yard. Alternatively the covering layer can be any other absorbent or non-absorbent material in the form of inter-woven fibers such as rayon, nylon, polyacrylate, polyester, polyamide, polyacryl, triacetate or polyethylene. Another alternative is to use a non-absorbent sheet of material such as polyethylene, polypropylene, vinyl, polyester, nylon etc with a large number of small holes to allow transfer of moisture. The layer having the salt contained therein or thereon is preferably a polypropylene/pulp blend, especially one having a weight of about 150 or 250 grams/sq. meter.

The moisture impermeable layer is preferably selected from poylpropylene, polyethylene, polyester, polyacrylate, vinyl, polyvinylchloride, polyvinylidene chloride, natural and synthetic latex, modified polyvinyl acetal resins, and copolymers and mixtures thereof, preferably polyethylene and/or polypropylene, most preferably polyethylene and being about 1 mil thick.

One method of adding the salt into the product is to add in during the manufacture of the absorbent layer, such as adding the salt to the wet pulp in the course of manufacture of a paper absorbent sheet. If the salt is desired to be in the form of a bicarbonate, the paper is dried in a carbon dioxide containing atmosphere or between 5 and 100% carbon dioxide, depending on the drying temperature and the desired ratio of bicarbonate:carbonate salt. Higher temperatures favor transforming bicarbonate to carbonate while higher carbon dioxide levels in the drying atmosphere resist this conversion. Precise carbon dioxide levels and drying temperatures will be determined by those of ordinary skill in the art in actual practice of this method of incorporation of the salt.

A second method of incorporating the salt is to sprinkle it on the surface of a suitable substrate layer followed by light misting of water or volatile solvent to tack the particles on the surface of the substrate. If the substrate is itself an absorbent layer, then the misting may result in the salt being partially or totally drawn into the absorbent layer rather than being simply tacked on the surface. A small amount of polyethylene glycol or surfactant can be added to the water or solvent so as to provide residual material to ensure that some or all of the salt particles are tacked on the surface. The substrate (generally paper) is then dried, preferably air dried. A typical embodiment in this variation is to apply baking soda at a rate of about 2.5 to 50 grams per 100 square feet of paper (the paper being a paper towel having a weight of about 2.5 g to 10 g per square foot). Then 50 to 250 grams of water containing 0.5% PEG 400 is misted onto the surface of the paper towel which is then allowed to air dry.

A third method of incorporation of the salt is to spray a solution of the salt onto the surface of the substrate and allow it to dry. If it is desired to maintain the salt entirely or mostly in the bicarbonate form, the drying should occur in an atmosphere having at least about 10% carbon dioxide, with higher levels needed for drying at higher temperatures. A typical embodiment in this variation would be to misting the surface of the paper towel with a 5% baking soda solution at a rate of 100 to 500 grams per 1200 square feet of paper towel. The paper towel is dried at 50° C. in an atmosphere of 10% carbon dioxide.

For a thicker non-woven substrate containing cellulosic or non-cellulosic fibers, it is most preferable to mix the fibers with the requisite level of salt so as to trap the salt within the fiber matrix most preferably at about 2% to 20% by weight of the fiber matrix. The sheet produced may be used as is, lined on one side with a moisture impermeable layer and/or lined on the other side with a porous material so as to reduce dusting of the salt from the matrix. The most preferred embodiments differ depending on the end use.

An important aspect of the invention is that products of the invention can be used as liners for shelves and bins such as for refrigerators, closets or drawers, as fish tray liners, as meat tray liners or liners for food surfaces and food preparation areas, as toilet seat liners or as absorbent materials for wiping the hands or surfaces or as toilet paper. Bacterial contaminants, which come in contact with the surface of these products, are rapidly killed and are not transferred when contact is subsequently made with other surfaces. Thus, for example, bacteria coming from the one person's hands and transferred to a treated paper or fabric towel are rapidly killed and are not transferred to a second person's hands who subsequently uses the paper or fabric towel. Additionally, bacteria from someone's hands or from food which contact a towels or liner of the invention are rapidly killed and not transferred to other food which are subsequently placed in contact with the towel or liner.

### EXAMPLES

### Example 1

Absorbent products, of 2 in.×2 in., weighing about 1 gram each, and being of identical construction except that 0%, 2%, 4%, 6%, 8%, 10% and 12% (per gram of product) of sodium bicarbonate was incorporated therein are used for this example. Each product had an identical top porous layer, an identical moisture impermeable backing layer and the same substrate absorbent layer (with the differing sodium bicarbonate levels) therebetween . Two ml of sterile water was added to each product. Each product was then inoculated with 0.1 ml of one of a bacterium or fungus selected from S. aureus (6.9×10⁵ CFU/ml), E. coli (5.4×10⁵ CFU/ml), P. aeruginosa (6.9×10⁵ CFU/ml), and C. albicans (5×10⁵ CFU/ml). Each inoculated product was incubated at 25° C. and kept moist in a petri dish. Microbial numbers were determined on days 7 and 14 Microbial numbers were determined by removing the product from the petri dish and placed in a bag with 9 ml of neutralizer broth, mixed and plated on Leethan Agar. These plates were then incubated for 48-72 hours at 30° C. and colonies on the plates were counted. The test results are reported in Table I below.

TABLE I

| Sodium Bicarbonate | Colony Forming Units/ml | | | |
|---|---|---|---|---|
| Concentration | S. aureus | E. coli | P. aeruginosa | C. albicans |

Day 7

| | | | | |
|---|---|---|---|---|
| 0% | 120 | 50 | 19,000 | <10 |
| 2% | <10 | <10 | <10 | 1,800 |
| 4% | <10 | <10 | <10 | 5 |
| 6% | <10 | <10 | 50 | <10 |
| 8% | <10 | <10 | 150 | 70 |
| 10% | 5 | <10 | <10 | <10 |
| 12% | <10 | <10 | <10 | 30 |

Day 14

| | | | | |
|---|---|---|---|---|
| 0% | 55 | 570 | 575 | 3000 |
| 2% | <10 | <10 | 15 | 15 |
| 4% | <10 | <10 | <10 | 450 |
| 6% | <10 | <10 | <10 | <10 |
| 8% | 10 | <10 | <10 | 3000 |
| 10% | <10 | <10 | <10 | <10 |
| 12% | <10 | <10 | <10 | <10 |

### Example 2

Product according to the invention was examined for the presence of microbes on unused (but not sterilized) invention product and compared to unused commercially available paper towels. Each was examined for anaerobic bacteria, aerobic bacteria, and mold/yeast. The unused results are shown in Table II below. The invention product in this example is a three layer product. The top layer is a Spunbond polypropylene material having a weight of about 1.3 oz/square yard. The middle layer is a blend of polypropylene and pulp weighing about 150 gm/square meter. The bottom layer is a moisture impermeable layer of 1 mil polyethylene. The middle layer has sodium bicarbonate 12% (by weight of the product) contained in the middle layer.

TABLE II
BIOBURDEN OF UNUSED INVENTION OR PAPER TOWEL
(CFU/gm)

| | Invention Samples | | | Paper Towels | |
|---|---|---|---|---|---|
| Aerobic Bacteria | 30 | 10 | 15 | <10 | 10 |
| Anaerobic bacteria | 300 | 255 | 256 | 270 | 100 |
| Total Mold/Yeast | 30 | 15 | 15 | <10 | 5 |

### Example 3

Product of the invention (as set forth in Example 2) is compared to Paper Towels and to Poultry Tray Liners and the ability of the materials to support bacterial growth. The tests are performed with 2 in×2 in sections of each of these materials which are inoculated, incubated, and tested in accordance with the procedure set forth in Example 1. The results are set forth in TABLE III below.

TABLE III
Colony Forming Units/ml

| Product | S. aureus | E. coli | P. aeruginosa | C. albicans | A. niger |
|---|---|---|---|---|---|
| Inoculation Level | 9.3 × 10⁵ | 7.3 × 10⁵ | 6.4 × 10⁵ | 4.6310⁵ | 4 × 10⁵ |
| | 7 Day | | | | |
| Invention | 3.4 × 10³ | 6 × 10¹ | 5.8 × 10² | 1.1 × 10⁵ | 1.5 × 10⁵ |
| Paper Towel | 8.7 × 10⁵ | >3 × 10⁶ | >3 × 10⁶ | 7.1 × 10⁵ | 1.9 × 10⁴ |
| Poultry tray liner | 4.5 × 10¹ | >3 × 10⁶ | >3 × 10⁶ | >3 × 10⁶ | >3 × 10⁶ |
| | 14 Day | | | | |
| Invention | 10 | <10 | <10 | 20 | 2.4 × 10⁵ |
| Paper towel | 1.1 × 10⁶ | >3 × 10⁶ | >3 × 10⁵ | 1.9 × 10⁵ | 4.2 × 10⁵ |
| Poultry tray liner | >3 × 10⁶ | >3 × 10⁶ | >3 × 10⁶ | 4.9 × 10⁵ | 1.5 × 10⁵ |
| | 28 Day | | | | |
| Invention | <10 | <10 | <10 | <10 | 2.2 × 10⁵ |
| Paper towel | >3 × 10⁴ | >3 × 10⁴ | >3 × 10⁴ | 3.7 × 10² | 3.7 × 10⁵ |
| Poultry tray liner | 55 | 70 | 530 | <10 | 1.7 × 10⁵ |

I/we claim:

1. A method of preventing or reducing microbial growth on a surface comprising lining said surface with an absorbent product in sheet form, said absorbent product comprising an absorbent layer and a salt which is selected from the group consisting of an alkali metal carbonate, ammonium carbonate, alkali metal bicarbonate, ammonium bicarbonate and mixtures thereof.

2. The method of claim 1 wherein said absorbent sheet is a product selected from the group consisting of a refrigerator shelf liner, a refrigerator bin liner, a paper towel, a toilet paper, a cloth towel, a toilet seat liner, a meat tray liner, a fish tray liner, and a liner for food preparation areas.

3. The method of claim 1 wherein said salt is selected from the group consisting of sodium bicarbonate, sodium carbonate, and mixtures thereof.

4. The method of claim 1 wherein said salt is selected from the group consisting of potassium bicarbonate, potassium carbonate, and mixtures thereof.

5. The method of claim 1 further comprising a moisture impermeable backing layer.

6. The method of claim 1 wherein said absorbent sheet comprises a backing layer, an absorbent layer and said salt is contained therebetween.

7. The method of claim 1 wherein said absorbent sheet comprises a backing layer, an absorbent layer and said salt is contained on or in said absorbent layer.

8. The method of claim 1 wherein said absorbent sheet comprises a backing layer, a non-absorbent cover layer, and a carrier layer therebetween, wherein said salt is contained in or on said carrier layer.

9. The method of claim 1 wherein said salt is present in an amount of at least about 0.1% by weight of said absorbent product.

10. The method of claim 1 wherein said salt is present in an amount of at least about 0.1% by weight of said absorbent product exclusive of any moisture impermeable backing layer which may be present

11. A method of preventing or reducing cross-contamination with microorganisms by lining a surface which is susceptible to being a vehicle for said cross-contamination with an absorbent product in sheet form, said absorbent product comprising an absorbent layer and a salt which is selected from the group consisting of an alkali metal carbonate, ammonium carbonate, alkali metal bicarbonate, ammonium bicarbonate, and mixtures thereof.

12. The method of claim 11 wherein said absorbent sheet is a product selected from the group consisting of a refrigerator shelf liner, a refrigerator bin liner, a paper towel, a toilet paper, a cloth towel, a toilet seat liner, a meat tray liner, a fish tray liner, and a liner for food preparation areas.

13. The method of claim 11 wherein said salt is selected from the group consisting of sodium bicarbonate, sodium carbonate, and mixtures thereof.

14. The method of claim 11 wherein said salt is selected from the group consisting of potassium bicarbonate, potassium carbonate, and mixtures thereof.

15. The method of claim 11 further comprising a moisture impermeable backing layer.

16. The method of claim 11 wherein said absorbent sheet comprises a backing layer, a non-absorbent layer and said salt is contained therebetween.

17. The method of claim 11 wherein said absorbent sheet comprises a backing layer, an absorbent layer and said salt is contained on or in said absorbent layer.

18. The method of claim 11 wherein said absorbent sheet comprises a backing layer, a non-absorbent cover layer, and a carrier layer therebetween, wherein said salt is contained in or on said carrier layer.

19. The method of claim 11 wherein said salt is present in an amount of at least about 0.1% by weight of said absorbent product.

20. The method of claim 11 wherein said salt is present in an amount of at least about 0.1% by weight of said absorbent product exclusive of any moisture impermeable backing layer which may be present.
